(19) United States
(12) Patent Application Publication
(10) Pub. No.: US 2009/0044600 A1
(43) Pub. Date: Feb. 19, 2009

(54) DEVICE FOR STORAGE AND AUTOMATIC RETRIEVAL OF CALBIRATION AND SYSTEM INFORMATION

(76) Inventor: Thomas C. Morse, Greenville, NC (US)

Correspondence Address: PATTERSON & SHERIDAN L.L.P. NJ Office, 595 SHREWSBURY AVE, STE 100, FIRST FLOOR, SHREWSBURY, NJ, 07702, US

(21) Appl. No.: 12/145,869

(22) Filed: Jun. 25, 2008

Related U.S. Application Data
(60) Provisional application No. 60/947,194, filed on Jun. 29, 2007.

(51) Int. Cl. G01N 15/08; G01N 1/38

(52) U.S. Cl. 73/38; 73/863

(57) ABSTRACT

Embodiments of the invention generally provide an apparatus and method for storing data relating to instrumentation used for certifying a filter in a containment system. The apparatus generally comprises a memory device communicatively coupled to one or more instruments of a sample system. The memory device stores a data set regarding the instrument. The data set is then accessed during testing of an air sample from the containment system.

### CROSS-REFERENCE TO RELATED APPLICATIONS

This application claims benefit to U.S. Provisional Patent Application Ser. No. 60/947,194, filed on Jun. 29, 2007.

### BACKGROUND OF THE INVENTION

1. Field of the Invention

The embodiments described herein generally relate to an apparatus and method for testing an air filter. More particularly, embodiments described herein relate to one or more memory devices capable of storing and conveying a data set associated with equipment utilized for testing an air filter.

2. Description of the Related Art

Numerous facilities handle hazardous and potentially fatal compounds and/or particles. These facilities include, for example, biological safety labs, pharmaceutical manufacturing facilities, biotechnology research labs, and production facilities. The hazardous particulates may include anything that is harmful or fatal to humans including, but not limited to, viruses, bacteria, chemicals, and waste products. Typically a containment system in the facility prevents the hazardous particles from escaping from the facility by filtering the air that exits the facility prior to entering the surrounding environment.

The containment system typically consists of multiple components arranged in series. The components generally include one or more filter housing sections, one or more filters disposed in the one or more filter housing sections, an upstream test section, a downstream test section, and an air tight damper for isolating the containment system from the upstream and downstream ductwork that the containment system is coupled thereto.

The performance of the filters disposed in the containment system is critical to prevent human exposure to the hazardous particles. Therefore, it is necessary to certify the performance of the filters prior to installation, and in many instances, on a regular recertification interval. The certification process ensures that the filters are meeting predefined operations criteria and/or standards. Filter certification (e.g., leak and/or efficiency testing) requires that air pass through the filter at the operational flow-rate while an aerosol challenge is injected upstream of the filter at a known concentration. Since the aerosol concentration is generally above the operational range of the test equipment utilized to determine the upstream concentration, the upstream sample is diluted prior to entering the test equipment. Samples of the air downstream of the filter are provided to the test equipment. Based on the upstream concentration derived from the analysis of the upstream sample, the number or other metric indicated of the number of particles present in the downstream sample may be utilized to determine filter leaks and/or the overall efficiency of the air filter.

Since the dilution ratio is critical to this process, the dilutor is frequency calibrated to ensure acceptable test results. Currently, calibration of the dilutor is performed in a lab. A lab technician applies a certification sticker to the dilutor. The certification sticker may include information such as the date of calibration, the calibration data, and the date of expiration. A certificate of calibration is also provided which may include the specifications for calibration, tolerances, as-found condition, and calibrated condition.

The technician performing the filter test verifies the calibration status of the dilutor prior to testing by checking the calibration dates. The make, model numbers, and calibration data are then hand written or typed into a test report during the certification process. Additionally, the upstream concentration is entered by the technician into a computer that determines the leak and/or filter efficiency. Because the calibration information is manually recorded and entered by the technician, there is a potential for error.

The accuracy of this data is critical in that any mistakes can result in testing errors. This can result in filters having poor efficiency and/or leaks exposing the environment and humans to potentially harmful particles in exhaust applications, or contaminating research or production areas. Further, several regulatory agencies impose penalties, fines, and imposed shutdowns and/or recalls of products when the filter testing process is performed with invalid certification.

Therefore, there is a need for a memory device capable of storing and relaying a data set related to one or more instruments of a containment system.

### SUMMARY OF THE INVENTION

Embodiments described herein generally relate to an instrument for diluting an air sample in a containment system. The instrument comprises a dilutor and a data set directly relating to an operational characteristic of the dilutor and a memory device affixed to the dilutor and having the data set stored thereon.

Embodiment described herein generally relate to a method for testing a filter. The method comprises passing an air sample taken upstream of the filter through a dilutor and automatically accessing a data set from a memory device affixed to the dilutor. The method further comprises determining a test criteria from information read from the data set and testing the filter utilizing the test criteria to determine at least one of filtration efficiency or filter leaks.

Embodiment described herein generally relate to a method for testing a filter. The method comprises passing a sample taken upstream of the filter through a dilutor to a tester and automatically accessing a data set from a memory device affixed to at least one of the dilutor or tester. The method further comprises testing the filter in response to a determination that testing should proceed based on the information read from the data set.

### BRIEF DESCRIPTION OF THE DRAWINGS

The accompanying drawings, which are incorporated in and constitute a part of the specification, schematically illustrate the present invention, and together with the general description given above and the detailed description given below serve to explain the principles of the invention.

FIG. 1 is a simplified schematic diagram for testing a filter according to one embodiment of the invention;

FIG. 2 depicts a schematic plan view of one embodiment of a memory device;

FIG. 3 depicts a sectional view of the containment system interfaced with filter test equipment incorporating the invention; and

FIG. 4 is a flow diagram of one embodiment of a method for testing a filter.

To facilitate understanding, identical reference numerals have been used, where possible, to designate identical elements that are common to the figures. It is contemplated that elements of one embodiment may be beneficially incorporated in other embodiments without further recitation.

### DETAILED DESCRIPTION

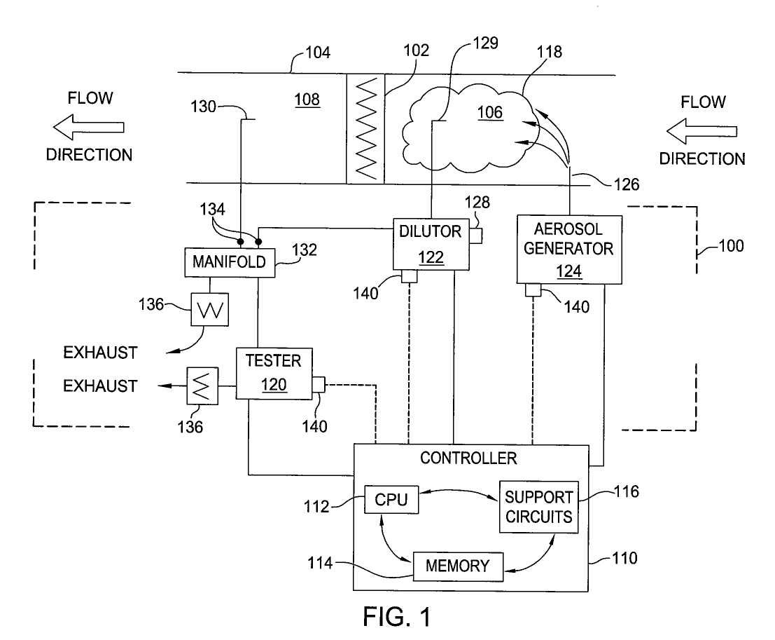

FIG. 1 is a schematic diagram of a filter 102 being tested using one embodiment of a test system 100. The filter 102 is disposed in a test fixture 104 or other housing which defines a region upstream 106 and a region downstream 108 of the filter 102 from which samples may be taken to facilitate testing of the filter 102. In the embodiment depicted in FIG. 1, the flow direction through the filter 102 and test fixture 104 is right to left.

The test system 100 generally includes a tester 120 and a dilutor 122. The test system 100 may also include an aerosol generator 124. A controller 110 is interfaced with at least the tester 120 so that determinations of leaks the filter 102 and/or an overall efficiency of the filter 102 may be calculated. The controller 110 may be part of the test system 100, be part of a system that controls the operation of the system in which the filter 102 is mounted, or be another suitable processor.

In one embodiment, the controller 110 comprises a central processing unit (CPU) 112, support circuits 116 and memory 114. The CPU 112 may be one of any form of computer processor that can be used in an industrial setting for controlling various chambers and subprocessors. The memory 114 is coupled to the CPU 112. The memory 114, or computer-readable medium, may be one or more of readily available memory such as random access memory (RAM), read only memory (ROM), floppy disk, hard disk, or any other form of digital storage, local or remote. The support circuits 116 are coupled to the CPU 112 for supporting the processor in a conventional manner. These circuits include cache, power supplies, clock circuits, input/output circuitry, subsystems, and the like. Instructions may be stored in the memory 114 so that the filter testing process described below may be automated.

Referring back to the test system 100, the tester 120 may be a photometer, particle counter, or other equipment suitable for leak and/or efficiency testing of the filter 102. The tester 120 is coupled to one or more downstream sample ports 130 positioned in the downstream region 108 of the test fixture 102. The tester 120 provides a metric indicative of the number of particles present in the samples taken through the sample port 130. The measured air sample exiting the tester 120 is exhausted from the test system 110 through an optional exhaust filter 136.

The aerosol generator 124 supplies aerosol to the upstream region 106 adjacent the filter 102 through an aerosol injection port 126. The aerosol generator 124 provides an aerosol to the upstream portions 106 of sufficient concentration to provide a statistically valid test of the filter 102.

A pressure transducer (transmitter) 128 may be interfaced with the line coupling the upstream sample port 129 to the dilutor 122. The pressure transducer 128 may be incorporated into the dilutor 122, or be a stand alone instrument.

The pressure transducer 128 provides the controller 110 with a metric indicative of the pressure of the line coupled to the dilutor 122. The dilution ratio, in some embodiments corresponding to the pressure in the upstream sample line, may be resolved utilizing the metric provided by the pressure transducer 128. The pressure transducer 128 may have an analog or digital output signal. For example, the output signal may be an analog signal such as mA or voltage signal. Common output signals are 4-20 Ma or 0-5 VDC; however, other suitable ranges are anticipated. The power for the pressure transducer 128 may be supplied by the power unit of a memory device 140. The output signal from the pressure transducer can be provided to one or more inputs on the memory device 140. The inputs can be analog or digital depending on the pressure transducer used.

At least the dilutor 122 includes the memory device 140. Other components of the test system 100, such as the tester 120 and/or aerosol generator 124 may optionally include a memory device 140. The memory device 140 stores one or more data sets relating to the instrumentation, such as the dilutor 122 or other device, to which it is attached. In one embodiment, the memory device 140 is coupled to the dilutor 122 such that the memory device 140 is transportable with the instrument to which it is attached, such as the dilutor 122 and/or the like.

In one embodiment, the memory device 140 includes information from both dilutor 122 and transducer 128. In embodiments where dilutors are utilized in series, information from all the dilutors, and/or information relating to the combined performance (e.g., total dilution characteristics) may be stored in the memory device 140.

In one embodiment, the memory device 140 is read/writable. For example, information regarding the instrumentation may be written to the memory device 140, such as information relating to a calibration curve (dilution ratio per flow rate through the dilutor) of the dilutor 122. Information may be written to the memory device 140 at calibration, the time that the device 140 is associated with a particular piece of equipment, or another appropriate time. The information residing on the memory device 140 may be read by the controller 110 and utilized for testing of the filter 102 as further described below.

The memory device 140 may use any suitable computer-readable storage media to retain the data set (i.e., information). For example the computer-readable storage media may include, but are not limited to: (i) non-writable storage media (e.g., read-only memory devices within a computer such as CD-ROM disks readable by a CD-ROM drive) on which information is permanently stored; and (ii) writable storage media (e.g., magnetic media such as tape or floppy disks, floppy disks within a diskette drive or hard-disk drive, optical media such as CD, DVD, Blue Ray, HDDVD, magneto-optical media, and a hard drive) on which alterable information is stored.

The memory device 140 stores the data set associated with the instrument to which it is attached. A single memory device 140 may be utilized for several pieces of equipment which are maintained as a set, or a dedicated memory device may be used for each respective piece of equipment. The description below will focus on the operation of the memory device 140 storing information associated with the dilutor 122. It should be appreciated that the use of the memory device 140 on other equipment would operate in the same manner as on the dilutor 122, except for that the data set may include different information. The memory device 140 stores the data set for access by an operator and/or the controller 110 for use during or in preparation for filter testing. The data set may be used to determine a condition of the instrument (calibration dates, end date of the calibration period, operational limits, system compatibility, and the like) and/or a characteristic of the instrument (dilution ratios, calibration curve, calibration data, and the like).

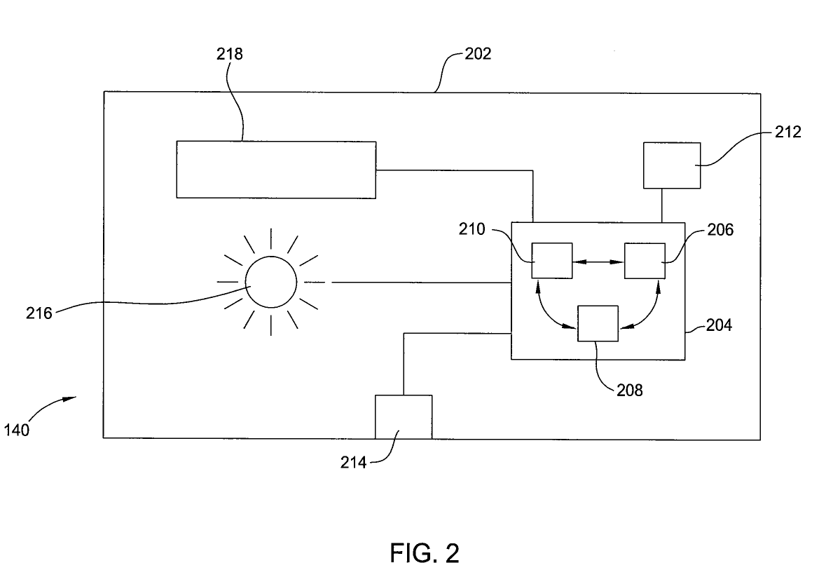

FIG. 2 depicts a schematic plan view of one embodiment of the memory device 140. The memory device 140 generally includes a base 202 having an on-board controller 204, a power source 212 and a communication port 214 coupled thereto. The base 202 facilitates coupling the memory device 140 to the instrument, for example, by fasteners, adhesives, clamps and the like.

The memory device 140 may be associated with a clock capable of associating the data set with a time. Thus, the memory device 140 may store and/or relay specific conditions of the instrument(s) in relation to a time. Therefore an operator, inspector, or controller 110 can determine the condition of the instrument(s) at a specific time in the past, and determine if the calibration period has expired.

The controller 204 includes a processor 206, support circuits 208 and a memory 210. The power source 212, which may be a lithium ion battery or other suitable power source, and provides power to the controller 204. The memory 210, or computer-readable medium, may be one or more of readily available memory such as random access memory (RAM), read only memory (ROM), floppy disk, hard disk, or any other form of digital storage, local or remote. The support circuits 208 are coupled to the processor 206 and/or memory 210 for supporting the processor and/or memory in a conventional manner. These circuits include cache, power supplies, clock circuits, input/output circuitry, subsystems, and the like. Instructions may be stored in the memory 210 so that the filter testing process described below may be automated.

The communication port 214 is coupled to the controller 204 and allows the memory 210 to be read and/or written to, such as through a serial port, a USB port, an Ethernet port, one or more analog-to-digital (A/B) input, a transponder, a transmitter or a receiver, among others. The communication port 214 allows the memory device 140 to communicate with the controller 110 or other electronic device (such as those used to input calibration data) in a suitable manner. In one embodiment, the communication port 214 of the memory device 140 is configured to send and receive data via wire. In other embodiments, the communication port 214 of the memory device 140 is configured to send and receive data via in a wireless manner (e.g., infrared, RF, Bluetooth, etc.).

The memory 210 of the memory device 140 may generally be configured to be read and/or writable an automated fashion (e.g., according to a preprogrammed sequence stored in memory) or according to explicit user input. Further, the controller 110 may establish communication with the memory device 140 either passively or actively.

In addition to the features described above, the memory device 140 may include an alarm 216 and visual display 218. The display 218 allows the operator to quickly retrieve and/or view data from the memory device 140. The display 218, for example, may indicate the calibration due date (e.g., the expiration of the calibration period).

The alarm 216 is utilized to alert an operator of potential problems and/or upcoming maintenance of the instrumentation to which the memory device 140 is attached or associated therewith. The alert of the alarm 216 may be an audible sound, visual alert, a combination of audible and visual alerts. In one example, the alarm can be a proactive alert relaying upcoming certification due dates or maintenance requirements to an operator. Further, the alarm can alert an operator when the calibration date has expired or if the operational parameters of the equipment to which the memory device 140 is affixed has been exceeded or is out of the operational window. The alarm 216 may further indicate that the memory device 140 has been tampered with. The frequency, duration, time, and date of the alarms can be programmed into the memory device 140 and/or the controller 110 when calibration is performed, or may be factory-preset.

Returning back to FIG. 1, the data set stored in the memory device 140 can include any suitable information about the instrumentation. The data set can comprise one specific piece of information about the instrumentation or may be multiple pieces of information about several aspects of the instrumentation and/or several instruments. The data set may specifically include, but is not limited to, the make, the model number, the calibration technician's name, the certification date, calibration due dates, serial numbers, the dilution factor, dilution curves, the dilution ratio, the calibration data, and/or the output from the pressure transducer 128. In one embodiment, the data set includes the dilution ratio at different dilutor operating parameters (such as at least one of pressure, temperature and flow rate).

In another alternative embodiment, the output from the pressure transducer 128 by-passes the memory device 140 and is sent directly to the controller 110. In this embodiment, the dilution information and calibration data are sent to the controller 110 from the memory device 140, while the output from the pressure transducer 128 is provided to the controller 110 independently so that the controller 110 may determine the upstream concentration, or utilize a similar metric in leak and/or efficiency calculations.

The controller 110 can automatically receive the data set including the calibration data from the memory device 140. In one example, if the calibration date is overdue, the controller 110 may flag the operator and/or prevent testing of the filter 102 using the out-of-calibration dilutor. In another example, the make, model number and serial number, along with the calibration date and/or history, may be recorded with the associated filter test results.

During the filter test sequence, the controller 110 can automatically receive the dilution ratio of the dilutor 122 from the memory device 140. The dilution ratio is used to calculate the upstream concentration of the aerosol challenge being used to challenge the filter 102. The filter test acceptance criteria is a direct function of the upstream concentration of aerosol. The dilution ratio varies from dilutor to dilutor, even when the dilutors are the same make and model number. If the dilution ratio is not updated after a calibration or change of the dilutor 122, a failing filter may meet incorrectly calculated pass criteria. Therefore, reliably storing and determining the proper dilution ratio for the dilutor 122 in the memory device 140 is important for reliable testing filter. Additionally, since the data set including the dilution ratio and calibration data may be automatically retrieved from the memory device 140, the data set is substantially tamper- and error-proof.

The controller 110 receives the information set from the instrumentation of the test system 100. For example, the information set may be a measurement of the air sample from the tester 120. The controller 110 then reconciles the data from the information set with information from the data set. The reconciliation allows any specific information regarding the instrumentation, for example the dilution ratio, to be factored into the information set obtained from the instrumentation. The controller 110 can then perform a certification of at least a portion of the filter 102 from the reconciled information set and data set.

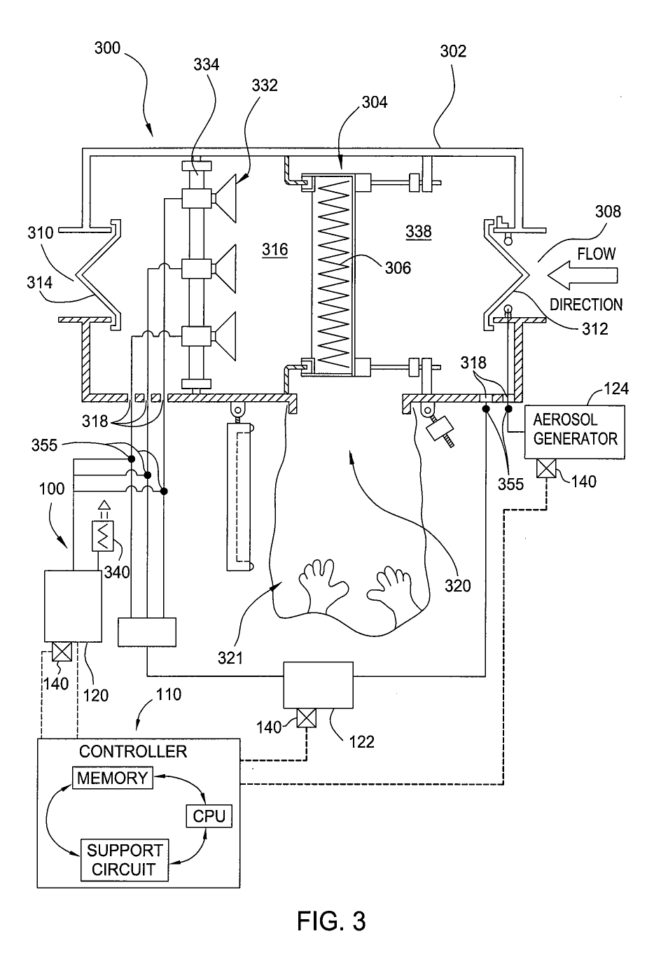

FIG. 3 is a sectional view of a containment system 300 interfaced with a testing system 100 containing at least one memory device 140 associated with at least one piece of equipment of the system 100. The containment system 300 ensures that air exiting or being recycled into a facility is substantially free of hazardous particles. The containment system 300 generally includes a housing 302 having one or more filters 306 disposed therein. One housing that may be adapted to benefit from the invention described in United States Patent Publication No. 2007/0044438, filed Apr. 28, 2006, which is incorporated by reference. Another housing that may be adapted to benefit from the invention is a CAMCONTAIN™ Containment System, available from Camfil Farr, Inc., Washington, N.C. It is contemplated that other containment housings, including those available from other manufacturers, may be adapted to benefit from the invention.

In one embodiment, the housing 302 includes a filter mounting portion 304 for sealingly mounting the filter 306 to the housing, an airflow inlet aperture 308 and an airflow exit aperture 310. Each aperture 308, 310 has a damper 312, 314 for controlling the flow of air through the housing 302 and filter 306. In one embodiment, the dampers 312, 314 may be configured with a bubble-tight seal so that leakage may be prevented through the apertures 308, 310.

The housing 302 includes a sealable filter access port 320 formed through the housing 302 adjacent the filter mounting portion 304 to facilitate installation and replacement of the filter 306. As common practice, the sealable filter access port 320 includes a bag-in bag-out system 321 to prevent exposure of technicians to hazards during filter replacement.

The housing 302 also includes a test section 316 and a plenum section 338. The test section 316 is positioned downstream of the filter mounting portion 304 while the plenum section 338 is positioned upstream of the filter mounting portion 304. The test section 316 includes one or more downstream sample ports utilized to test the filter 102 disposed in the housing 302. The plenum section 338 is generally configured to provide sufficient space for mixing elements to provide an even distribution of aerosol challenge upstream of the filter 306.

A plurality of ports 318 are formed through the housing 302 to accommodate taking downstream samples from the test section 316, delivering aerosol to the plenum section 338, and to accommodate taking upstream samples from the plenum section 338. Each port 318 is fitted with a valve assembly 355, shown schematically, to selectively open and close the respective port 318.

In the embodiment depicted in FIG. 3, the downstream sample ports disposed in the test section 316 are coupled to one or more probes 332 and a support structure 334. The support structure 334 positions the one or more probes 332 in the housing 302. The support structure 334 may statically hold the probes in a predefined position, or may be configured with one or more actuators, such as an x/y displacement mechanism, which dynamically positions (e.g., scans) the probe 332 along the downstream surface of the filter 302. The one or more probes 332 may have a design suitable for scan and/or efficiency testing. In one embodiment, the one or more probes 332 conform to IEST-RP-CC034.1 Recommended Practices.

The valve assembly 355 can be a single valve or a plurality of valves. The valve assembly 355 can have mechanical or automated actuation. The valve assembly 355 can include manual or electronic lockout. The lockout prevents inadvertent actuation of the valve assembly 355. Further, the valve assembly 355 can have position sensors that provide the controller 110 with a metric indicative of the state of the valve. The controller 110, in response to metric, can electronically lockout the valve assembly 355. Further, the valve assembly 355 can have a sensor to determine if lines to the test system 100 are coupled to valve assembly 355 to prevent inadvertent actuation. In another embodiment, the valve assemblies 355 may be locked-up in response to information obtained from the memory device 140 to prevent filter testing.

The containment system 300 is coupled to the test system 100 to facilitate testing of the filter 306 disposed in the housing 302. The test system 100 includes the dilutor 122, the aerosol generator 124 and the tester 120. At least the dilutor 122 and optionally the tester 120 and/or aerosol generator 124, has a memory device 140 coupled thereto.

The aerosol generator 124 supplies aerosol to the upstream side of the filter 306 through at least a valve assembly 355 coupled to the plenum section 338. The aerosol generator 124 provides an aerosol to the plenum section 338 which is used to challenge of the filter 306 during testing.

The dilutor 122 is coupled between the upstream sample port and the tester 120. The dilutor 122 is utilized to determine the upstream aerosol concentration in the plenum section 338.

The tester 120 measures the particles present in the air samples taken from the test section 316 and plenum section 338 of the containment system 300 through the sample ports 318. The tester 120 may be a photometer, particle counter, or other equipment suitable for leak and/or efficiency testing of the filter 306. The tester 120 provides an information set about the air sample to an operator or the controller 110. The information set can be a metric indicative of the number of particles present in the air samples. The measured air sample exiting the tester 120 is exhausted from the test system 100 through an optional exhaust filter 340.

At least one component of the test system 100, e.g., the tester 120, the dilutor 122 and/or the aerosol generator 124 may couple to or be integral with a memory device 140. The memory device 140 stores and relays one or more data sets relating to the instrumentation. The data set is used to automatically obtain accurate conditions of the instrumentation and/or conditions inside the contamination system 100.

In the embodiment depicted in FIG. 3, the dilutor 122 is integral with or coupled to the memory device 140. The memory device 140 stores and makes accessible the data set, for example, to the controller 110. The data set contains specific information relating to the dilutor 122, as discussed above. The data set may be used in conjunction with information provided from the transducer 128 so that the upstream concentration, and ultimately the performance of the filter 306. Further, the data set may be used to obtain information about the dilutor 122. Further, the data set may be used to perform maintenance to the dilutor 122.

Once enabled, an operator may control the operation of the containment system 300, the test system 100, the aerosol generator 124 and the dilutor 122 by inputting commands into the controller 110. To this end, another embodiment of the controller 110 and/or the memory device 140 can include a control panel, not shown. The control panel may include a key pad, switches, knobs, a touch pad, etc. The controller 110 and/or the memory device 140 can further comprise a visual display.

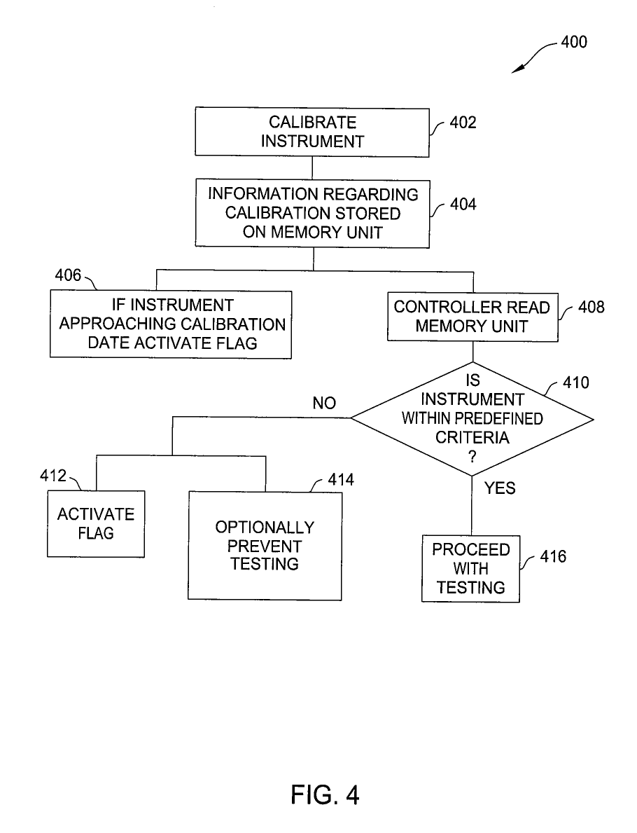

FIG. 4 depicts a flow chart is a flow diagram of one embodiment of a method 400 for testing a filter. The method 400 is primarily described with reference to information relating to the dilutor 122, however, the method 400 may also be utilized with other instruments having an associated memory device 140, as described above.

The method 400 begins step 402 wherein information relating to the instrument of the testing system 100 is obtained. In one embodiment, at least calibration information is obtained. Calibration information may be obtained during the calibration of the instrument. The calibration may be performed by a technician or automatically. At step 404, wherein the instrument of the testing system 100 has information associated therewith stored on an associated memory device 140. In one embodiment, at least calibration information, for example, of the diluter 122, is written to the memory of the memory device 140.

At an optional step 406, the processor of the memory device 140, or other device having access to the memory of the memory device 140, causes a flag to be generated if the instrument is at least one of out of calibration, exposed to out of specification environmental conditions (such as temperature, pressure, concentration, flow rate, humidity and the like), or is within a predefined period of the calibration date. The flag may be any suitable method of storing and/or conveying the approaching calibration date and/or out-of-calibration condition, including at least one of storing the information for later use, activating an alert of the alarm 216, displaying an alert on the visual display 218, relaying the information to the controller 110 or preventing calibration information to be read.

At step 408, the controller 110 reads information, the data set, from the memory unit 140. At step 410, the controller 110 determines whether the instrument is within predefined criteria (such as within calibration, inside of the calibration period, or exposed to conditions inside of the dilutor's operational capabilities.) If the instrument, e.g., the dilutor 122, is not within the predefined criteria, a flag may be activated, as shown in step 412. The flag may be as described above. Further, if the instrument is not within the predefined criteria, the memory unit 140 and/or the controller 110 may optionally prevent certification or testing from continuing and/or commencing, as shown in step 414. If the information read from the memory device 140 affixed to the dilutor 122 indicates that the predefined criteria is met, controller 110 allows testing of the filter to proceed at step 416.

In one embodiment, testing may be performed for leaks and/or efficiency. In one example, testing is performed by first providing an aerosol provided by the aerosol generator 124 to the plenum section 338. An upstream sample is routed from the plenum section 338 through the dilutor 122 to the tester 120. The controller 110, utilizing information read from the memory device 140 of the dilutor 122, resolves the upstream concentration and/or filter test acceptance criteria, such as particle and/or penetration limits.

The aerosol-laden air travels through the filter 306 mounted in the filter portion 304 of the housing 302 and into the test section 316. Some of the air passing through the filter 306 enters the one or more probes 332 disposed in test section 316. A valve assembly 355 controls the sequence of downstream samples obtained through the probes 332 to the tester 120.

The tester 120 analyzes the downstream samples obtained from the test section 316 and provides a data set to the controller 110. The air sample may exhaust from the tester 120 through an optional exhaust filter 340. The controller 120 analyses the downstream samples and utilizing the upstream concentration and/or test acceptance criteria, determines at least one of filter leaks, filter efficiency and/or pass or fail of the filter based on filter performance specifications.

To facilitate testing, the controller 110 establishes communication with the memory device 140 and/or other instrumentation of the test system 100. The controller 110 receives the data set from the tester 120. Further, the controller 110 can automatically receive at least the data set from the dilutor 122, the aerosol generator 124 and/or the tester 120.

If the filter 306 passes the testing criteria, the contamination system 300 can resume normal operation. If the filter 306 fails to meet the testing criteria, remedial action is taken, such as marking the filter as non-conforming or repairing leaks, among other remedial actions.

The memory device 140 continues to store and optionally relay the data set to the controller 110. The memory device 140 may alert the controller and/or the operator when maintenance is to be performed on the instrumentation coupled to or integral with the memory device 140 such as the dilutor 122.

While the foregoing is directed to embodiments of the present invention, other and further embodiments of the invention may be devised without departing from the basic scope thereof, and the scope thereof is determined by the claims that follow.

What is claimed is:

1. An instrument for diluting an air sample in a containment system, comprising:
a dilutor;
a data set directly relating to an operational characteristic of the dilutor; and
a memory device affixed to the dilutor and having the data set stored thereon.

2. The instrument of claim 1, wherein the data set includes dilution ratio information.

3. The instrument of claim 1, wherein the data set is a calibration data.

4. The instrument of claim 1, wherein the memory device further comprises an alarm.

5. The instrument of claim 1, wherein the memory device further comprises a communication port configured to allow the data set to be read.

6. The instrument of claim 1, wherein the memory device further comprises a display.

7. A method for testing a filter, comprising:
passing an air sample taken upstream of the filter through a dilutor;
automatically accessing a data set from a memory device affixed to the dilutor;
determining a test criteria from information read from the data set; and
testing the filter utilizing the test criteria to determine at least one of filtration efficiency or filter leaks.

8. The method of claim 7, wherein the data set comprises at least one of a calibration date of the dilutor, calibration ratio information, dilutor operational information or dilutor performance information.

9. The method of claim 7 further comprising:
calibrating the dilutor, and
writing calibration information to the memory device.

10. The method of claim 7, wherein the dilutor further comprises:
two or more dilutors coupled in series, wherein the data set includes at least one of calibration information for each dilutor or the combined calibration information of the dilutors in series.

11. The method of claim 7, wherein the data set contains a changed parameter of the dilutor during a calibration process.

12. The method of claim 7 further comprising:
automatically accessing a data set from a memory device affixed to a tester utilized to test the filter.

13. The method of claim 12, wherein the data set associated with the tester further comprises calibration information.

14. The method of claim 7, wherein determining the test criteria from information read from the data set further comprise:
accounting for pressure of the upstream sample.

15. A method for testing a filter, comprising:
passing a sample taken upstream of the filter through a dilutor to a tester;
automatically accessing a data set from a memory device affixed to at least one of the dilutor or tester; and
testing the filter in response to a determination that testing should proceed based on the information read from the data set.

16. The method of claim 15 further comprising:
determining a test criteria from information read from the data set.

17. The method of claim 16, wherein determining test criteria from information read from the data set further comprises:
accounting for pressure of the upstream sample.

18. The method of claim 15 further comprising:
initiating an alarm in response to a determination that testing should not proceed based on the information read from the data set.

19. The method of claim 15 further comprising:
calibrating the dilutor, and
writing calibration information to the memory device.

20. The method of claim 19, wherein the data set comprises at least one of a calibration date of the dilutor, calibration ratio information, dilutor operational information or dilutor performance information.
